(19) United States
(12) Patent Application Publication
(10) Pub. No.: US 2026/0243359 A1
(43) Pub. Date: Aug. 20, 2026

(54) VALVE ARRANGEMENT

(71) Applicant: HYDROHERTZ LTD, NOTTINGHAM (GB)

(72) Inventor: Martyn TALBOT, NOTTINGHAM (GB)

(21) Appl. No.: 19/489,621

(22) PCT Filed: May 29, 2024
(86) PCT No.: PCT/GB2024/051372

§ 371 Date: Dec. 3, 2025

(30) Foreign Application Priority Data
Jun. 4, 2023 (GB) 2308330.6

(51) Int. Cl. F16K 11/085; F16K 31/04

(52) U.S. Cl. CPC F16K 11/0856; F16K 31/041

(57) ABSTRACT

There is provided a valve arrangement comprising first and second valve components. The first valve component provides a plurality of discrete flow channels. Each of the discrete flow channels has an inlet aperture and one or more outlet apertures. The second valve component provides a port arrangement having an inlet port and at least two outlet ports. The first and second valve components are movable relative to each other between a plurality of open flow positions. In each of the open flow positions, the port arrangement is aligned with a different one of the discrete flow channels, such that the inlet port is brought into fluid connection with the inlet aperture of said flow channel, and at least one outlet port is brought into alignment with at least one outlet aperture of said flow channel.

### CROSS-REFERENCE TO RELATED APPLICATIONS

This application is a U.S. national stage application of PCT/GB2024/051372, filed 29 May 2024, which claims priority to United Kingdom Patent Application No. GB2308330.6, filed 4 Jun. 2023, the entire disclosures of which are hereby incorporated by reference.

### BACKGROUND

Valve arrangements operate to control, regulate or direct flow within a system or process. Whilst many valve arrangements accomplish the same outcome—opening or closing of flow passages—how they mechanically do so can vary. Indeed, there are many valve arrangement design variations, dependent on the type of fluid flow, and the number of passages being controlled.

### BRIEF DESCRIPTION OF THE FIGURES

For a fuller understanding of the nature and objects of the disclosure, reference should be made to the following detailed description taken in conjunction with the accompanying drawings, in which:

FIG. 1 is a three-dimensional view of an inner core of a valve arrangement according to an embodiment of the invention.

FIG. 2 is a cross-sectional view through the inner core of the valve arrangement of FIG. 1, about line A-A.

FIG. 3 is a two-dimensional view of the outer surface of the circumferential wall of the inner core of the valve arrangement of FIG. 1.

FIG. 4 is an exploded view of an outer casing of a valve arrangement according to an embodiment of the invention.

### DETAILED DESCRIPTION

A two-way valve arrangement has two ports-an inlet and an outlet-and a valve between the inlet and the outlet. If the valve is open, then the two ports are connected, and fluid can flow therebetween. If the valve is closed, then the two ports are isolated, and fluid cannot flow therebetween.

In a system where multiple outlet ports are present, a plurality of two-way valve arrangements are required in order to control delivery to these outlet ports, which takes up unnecessary space, and requires significant operating control.

Three-way valve arrangements do exist, and connect an inlet to two outlets, controlling fluid flow between the inlet and the first outlet (typically a supply port), and the inlet and the second outlet (typically an exhaust port). When the valve is operating in a first position, fluid flow is enabled between the inlet and the first outlet, and fluid flow is prevented between the inlet and the second outlet. When the valve is operating in a second position, fluid flow is enabled between the inlet and the second outlet, and fluid flow is prevented between the inlet and the second outlet. Hence, these valve arrangements are not capable of permitting fluid flow to the first and second outlets simultaneously, which is desirable in many systems. Moreover it is often desirable to control flow from an inlet to more outlet ports, for example three outlet ports, four outlet ports, or greater.

There has now been devised an improved valve arrangement, which overcomes or substantially mitigates disadvantages associated with the prior art.

According to a first aspect of the invention there is provided a valve arrangement comprising first and second valve components, the first valve component providing a plurality of discrete flow channels, each of the discrete flow channels having an inlet aperture and one or more outlet apertures, and the second valve component providing a port arrangement having an inlet port and at least two outlet ports, the first and second valve components being movable relative to each other between a plurality of open flow positions, wherein in each of the open flow positions the port arrangement is aligned with a different one of the discrete flow channels, such that the inlet port is brought into fluid connection with the inlet aperture of said flow channel, and at least one outlet port is brought into alignment with at least one outlet aperture of said flow channel.

The valve arrangement according to the first aspect of the invention may be advantageous in that the number of discrete flow channels provided by the first valve component is not limited. Thus, this arrangement enables each discrete flow channel to provide a different configuration of one or more outlet apertures, so that when the valve components are moved relative to each other between the plurality of open flow positions, a different configuration of open and closed outlet ports can be provided, thereby enabling greater control of flow from an inlet to two or more outlet ports than was possible in the prior art.

The first valve component may be an inner valve component. The second valve component may be an outer valve component. The second valve component partially or fully surround the first valve component.

The first valve component and the second valve component may be arranged concentrically. The second valve component may be arranged concentrically about the first valve component. The first valve component and the second valve component may be arranged about the same central longitudinal axis.

The relative movement of the first and second valve components may be controlled by a positioning motor. The positioning motor may move the first valve component relative to the second valve component. Alternatively, the positioning motor may move the second valve component relative to the first valve component. The relative movement of the first and second valve components may be automated. Control of the positioning motor may therefore be automated. For example, relative movement of the first and second valve components may be controlled based on preset timings and/or a predetermined volume of fluid flow through the valve arrangement or a portion of the valve arrangement. The valve arrangement may therefore comprise a controller and/or a processor for monitoring said timings and/or volume of fluid flow, and/or controlling said automation.

The first and second valve components may be rotatable relative to each other. The positioning motor may therefore be a rotational motor.

The plurality of discrete flow channels may be formed in an external wall of the first valve component. The inlet apertures of the discrete flow channels formed in an exterior surface of the external wall of the first valve component. The one or more outlet apertures of the discrete flow channels may be formed in an exterior surface of the external wall of the first valve component.

The first valve component may be cylindrically shaped. The second valve component may be cylindrically shaped. It is envisaged that alternative shapes are possible, particularly in relation to the second valve component, which may be cuboidal, or example.

The discrete flow channels may be spaced about the circumference of the first valve component, e.g. equidistantly spaced about the circumference of the first valve component. The flow positions may be spaced about the circumference of the first valve component, e.g. equidistantly spaced about the circumference of the first valve component.

The discrete flow channels may run parallel to a longitudinal axis of the first valve component and/or the second valve component.

The inlet port and the at least two outlet ports may be through-ports that extend through a wall of the second valve component.

At least one of the discrete flow channels may comprise two or more outlet apertures. This may enable simultaneous flow to two or more outlets connected to the port arrangement in use.

The port arrangement may have at least three outlet ports. In this arrangement, at least one of the discrete flow channels may comprise three or more outlet apertures. This may enable simultaneous flow to three or more outlets connected to the port arrangement in use. The port arrangement may have at least four outlet ports. In this arrangement, at least one of the discrete flow channels may comprise four or more outlet apertures. This may enable simultaneous flow to four or more outlets connected to the port arrangement in use. The port arrangement may have at least five outlet ports. In this arrangement, at least one of the discrete flow channels may comprise five or more outlet apertures. This may enable simultaneous flow to five or more outlets connected to the port arrangement in use.

The first valve component may further provide at least one discrete closed channel. The discrete closed channel may comprise no outlet apertures. The first and second valve components may be movable relative to each other to a closed position. In the closed position, the port arrangement may be aligned with the discrete closed channel, such that none of the at least two outlet ports are aligned with an outlet aperture. This may prevent flow to any of the outlets connected to the port arrangement in use.

The discrete flow channels may define an outlet configuration. The outlet configuration may comprise the one or more outlet apertures. Each of the discrete flow channels may define a different outlet configuration. The outlet configuration of at least one discrete flow channel may have at least one closed position. The at least one closed position may be arranged such that when the first and second valve components are moved relative to each other to the open flow position in which the port arrangement is aligned with that at least one discrete flow channel, at least one outlet port of the second valve component is brought into alignment with the at least one closed position. This may prevent fluid flow to that at least one outlet port in use, thereby preventing fluid flow to an outlet connected to that at least one outlet port in use.

The port arrangement may comprise an inlet connector arranged to fluidly connect the inlet port to an inlet flow in use. The port arrangement may comprise at least two outlet connectors arranged to fluidly connect the at least two outlet ports to at least two separate outlets in use.

The at least two outlet connectors may be individually or collectively adjustably movable relative to the second valve component to adjust the resistance to flow through the at least two outlet ports in use. This may enable restriction of flow into any outlets connected to the at least two outlet ports of the port arrangement in use.

According to a second aspect of the invention, there is provided a system comprising two or more valve arrangements according to the first aspect of the invention.

The system may therefore comprise a first valve arrangement and a second valve arrangement. At least one of the one or more outlet ports of the second valve component of the first valve arrangement may be fluidly connected to an inlet port of the second component of a second valve arrangement.

The first valve arrangement and the second valve arrangement may be arranged concentrically. The second valve arrangement may be arranged concentrically about the first valve arrangement. The first valve arrangement and the second valve arrangement may be arranged about the same central longitudinal axis.

Practicable embodiments of the invention will now be described, by way of example only.

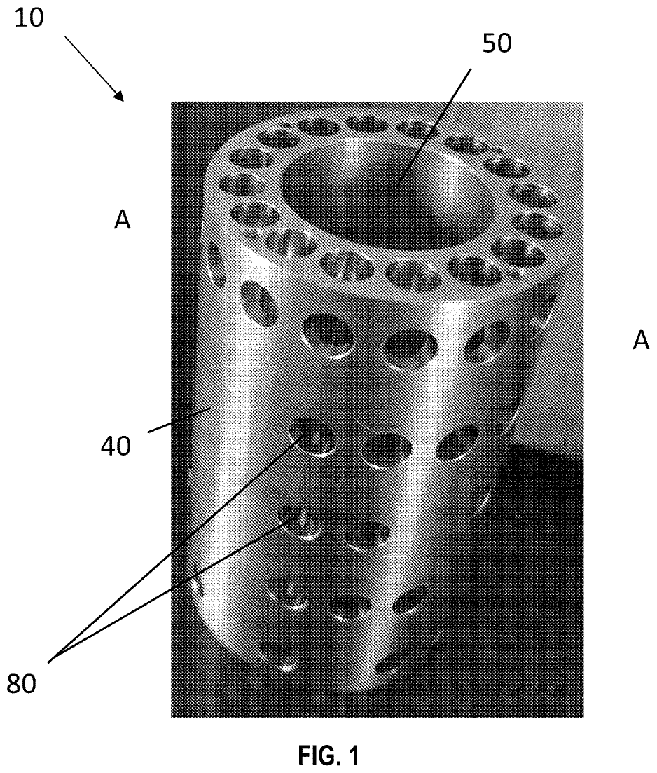

FIG. 1 illustrates a three-dimensional view of an inner core 10 of a valve arrangement.

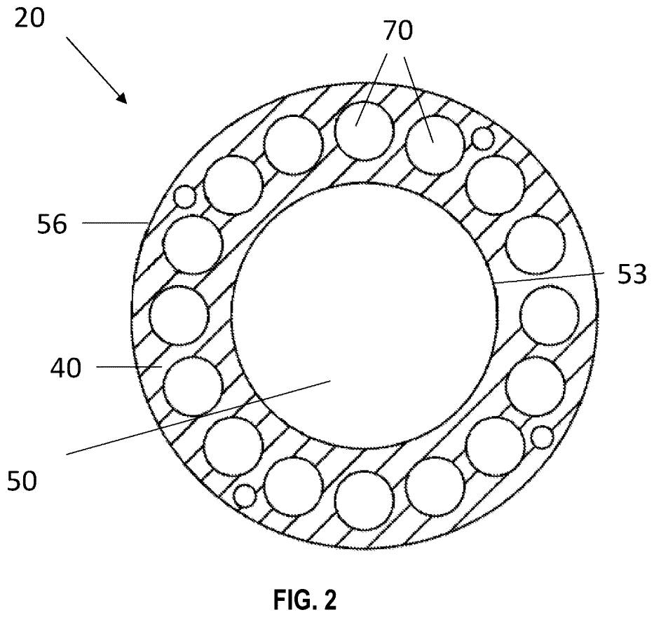

The inner core 10 is a hollow cylinder that forms a circumferential wall 40 about a passage 50. FIG. 2 illustrates a cross-section through the inner core 10, about line A-A of FIG. 1. The circumferential wall 40 has an inner surface 53 and an outer surface 56. Formed in the circumferential wall 40 are a plurality of channels 70, which are equidistantly spaced around the circumference of the inner core 10. Each of the channels 70 runs longitudinally through the circumferential wall 40, fluidly connecting one or more holes 80.

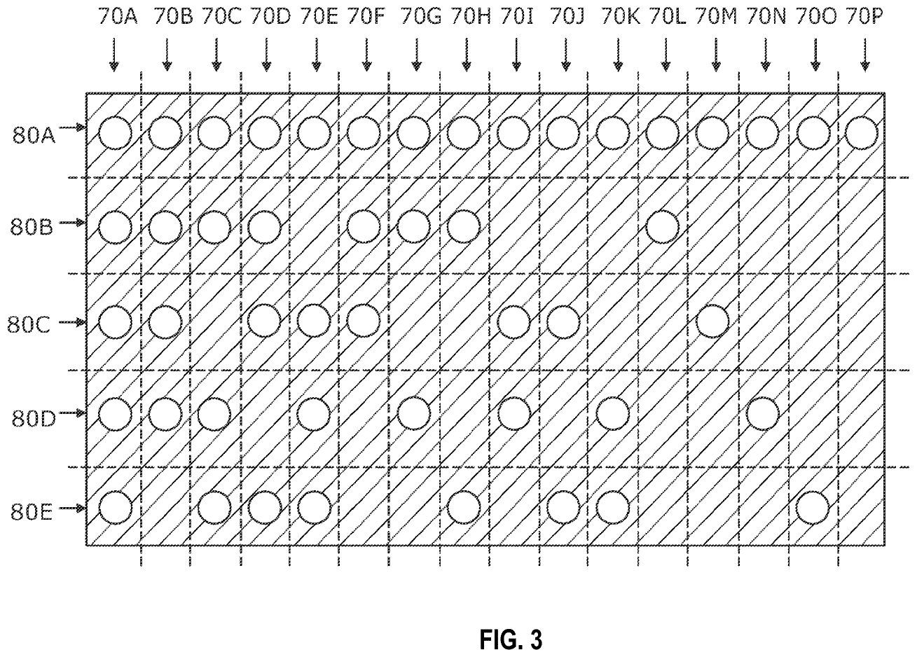

The arrangement of the one or more holes 80 of each channel 70 is shown in relation to FIG. 3, which illustrates a two-dimensional view of the outer surface 56 of the circumferential wall 40 of the inner core 10.

In this embodiment, the inner core 10 has 16 channels 70A-70P. Each channel 70 comprises an inlet hole 80A, and a combination of 0-4 outlet holes 80B-80E, which in use are fluidly connectable to first, second, third and fourth outlets respectively. In particular, in this embodiment:
The first channel 70A comprises four outlet holes 80B, 80C, 80D, 80E connectable to first, second, third and fourth outlets in use.
The second channel 70B comprises three outlet holes 80B, 80C, 80D, connectable to first, second, and third outlets in use.
The third channel 70C comprises three outlet holes 80B, 80D, 80E connectable to first, third and fourth outlets in use.
The fourth channel 70D comprises three outlet holes 80B, 80C, 80E connectable to first, second and fourth outlets in use.
The fifth channel 70E comprises three outlet holes 80C, 80D, 80E connectable to second, third and fourth outlets in use.
The sixth channel 70F comprises two outlet holes 80B, 80C connectable to first and second outlets in use.
The seventh channel 70G comprises two outlet holes 80B, 80D connectable to first and third outlets in use.
The eighth channel 70H comprises two outlet holes 80B, 80E connectable to first and fourth outlets in use.
The ninth channel 701 comprises two outlet holes 80C, 80D connectable to second and third outlets in use.
The tenth channel 70J comprises two outlet holes 80C, 80E connectable to second and fourth outlets in use.
The eleventh channel 70K comprises two outlet holes 80D, 80E connectable to third and fourth outlets in use.
The twelfth channel 70L comprises one outlet hole 80B connectable to a first outlet in use.
The thirteenth channel 70M comprises one outlet hole 80C connectable to a second outlet in use.
The fourteenth channel 70N comprises one outlet hole 80D connectable to a third outlet in use.
The fifteenth channel 700 comprises one outlet hole 80E connectable to a fourth outlet in use.
The sixteenth channel 70P comprises no outlet holes connectable to no outlets in use, effectively closing the valve arrangement and preventing the transport of fluid completely.

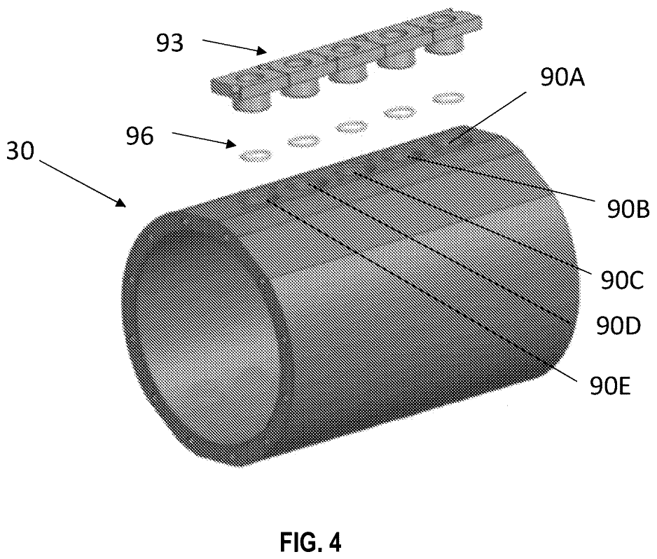

FIG. 4 illustrates an exploded view of an outer casing 30 for the valve arrangement.

Outer casing 30 comprises inlet hole 90A and four outlet through-holes 90B, 90C, 90D, 90E, which in use are fluidly connectable to first, second, third and fourth outlets respectively. An outlet connector 93 is positioned within the inlet hole 90A and each of the outlet holes 90B, 90C, 90D, 90E to enable connection to the inlet and the respective outlets, for example via standard tubing, piping or hosing. The fluid connections between the connectors 93 and the inlet hole 90A and outlet holes 90B, 90C, 90D, 90E is sealed using an O-ring 96, as is the connection between the holes 80A, 80B, 80C, 80D, 80E of the inner core 10 and the holes 90A, 90B, 90C, 90D, 90E of the outer casing 30 (not shown). The positioning of the connectors 93 and O-rings 96 may be adjustable relative to the inner surface of the outer casing 30 to provide higher or lower resistance to fluid flow through the holes 90A, 90B, 90C, 90D, 90E of the outer casing 30.

In use, the outer casing 30 is positioned around the inner core 10, such that the inner core 10 and the outer casing 30 are arranged concentrically, sharing a central longitudinal axis. The inner core 10 and the outer casing 30 are rotatable relative to one another such that the inlet hole 90A and four outlet holes 90B, 90C, 90D, 90E of the outer casing 30 may be aligned with the holes 80 of any of the 16 channels, dependent on the desired delivery of fluid to the first, second, third and fourth outlets.

For example, where the operator wishes to deliver fluid from an inlet to first and third outlets, but wishes to prevent delivery from the inlet to second and fourth outlets, the relative rotation of the inner core 10 and the outer casing 30 will be controlled such that the inlet hole 90A and four outlet holes 90B, 90C, 90D, 90E of the outer casing 30 are aligned with the seventh channel 70G of the inner casing 20. The seventh channel 70G of the inner casing 20 has an inlet hole 80A and outlet holes 80B, 80D which enables fluid to be delivered from an inlet to first and third outlets, but does not have outlet holes 80C, 80E, which prevents delivery from the inlet to second and fourth outlets. The fluid flow may be gas flow or liquid flow.

The inner core 10 having 16 channels enables the provision of all possible open-closed combinations for the four outlets via a single valve arrangement, by rotating the inner core 10 and the outer casing 30 relative to each other to select the desired combination of the four outlets.

The relative rotation of the inner core 10 and the outer casing 30 may be controlled by a positioning motor, which may itself be controlled by software. This motor may also utilise a gear box to ensure accurate positioning. The positioning motor attached to the valve arrangement can be any high or low voltage motor capable of withstanding the rated pressures of the valve in each typical use. The typical choice would be a servo motor, as this can be controlled from external hardware/software much easier than other motors. However, any motor may be used where the system can incorporate the correct control mechanisms and signals required to function the valve as required.

The valve arrangement may be utilised as part of a larger valve system. For example, each of the associated outlets may comprise a further valve arrangement, that controls the flow of fluid after delivery via the outlet holes 90B, 90C, 90D, 90E. The additional valve arrangement(s) may be further valve arrangements akin to that described above, or simple two-way valves known in the art.

For example, a first valve arrangement may be positioned in series with further valve arrangements 10. This may be useful, for example, for delivering fluid across different floors of a building, where the first valve arrangement controls delivery of the fluid to the various floors of the building, and the further valve arrangements 10 control delivery of the fluid to the various outlets on each floor.

Alternatively, multiple valve arrangements 10 may be arranged concentrically, such that the inner core of a second valve arrangement encases the outer casing of the first valve arrangement, and the valve arrangements are rotatable relative to one another to provide further inlet-outlet combinations. In this embodiment, the holes 80B-80E of the inner core of the second (outer) valve arrangement would be through holes, effectively acting as inlet holes in the second valve arrangement, such that fluid could flow from the outlet holes 80B-80E of the first (inner) valve arrangement into the holes 80B-80E of the outer valve arrangement.

Although the described embodiment shows an inner core having 16 channels for use with four outlets, it is envisaged that an alternative inner core could be provided for use with more or less outlets, by varying the number of channels according to the number of possible open-closed combinations based on the number of outlets. For example, an inner core with 8 channels could be provided for use with three outlets.

The outer surface 56 of the circumferential wall 40 of the inner core 10 may comprises a removable plate on which the seals are positioned, so that maintenance and/or replacement of the seals can be carried out much easier.

Additionally or alternatively, a removable plate may be provided on the inner and/or outer surface of the outer casing 30, for the same purpose. The specific seal type may be dependent on the fluid flow being controlled by the valve arrangement.

In alternative embodiments, the outer casing 30 may comprise an additional set of holes 90A, 90B, 90C, 90D, 90E, for example positioned circumferentially opposite the described holes 90A, 90B, 90C, 90D, 90E. This embodiment may be particularly useful for controlling hot and cold fluid flows simultaneously, for example in a heat pump or alternative refrigerant system. In this example, the first set of outer casing 30 holes 90A, 90B, 90C, 90D, 90E controls the cold fluid flow, and the second set of outer casing 30 holes 90A, 90B, 90C, 90D, 90E controls the hot fluid flow. In this example, the inner core 10 channels 70A-70P and the two sets of outer casing 30 holes 90A, 90B, 90C, 90D, 90E can be arranged so that when flow to a connected outlet is open for cold fluid flow, it is closed for hot fluid flow, and when fluid flow to a connected outlet is closed for cold fluid flow, it is open for hot fluid flow.

This may be implemented, for example, by positioning the two sets of outer casing 30 holes 90A, 90B, 90C, 90D, 90E circumferentially opposite on the outer casing 30, and by positioning each of the alternative channel arrangements, e.g. 70G and 70J in the example of FIG. 3, circumferentially opposite. Indeed, the arrangement of channels 70 in FIG. 3 is only an example arrangement.

The use of an additional set of holes could also be useful where different restrictions to flow are desirable. For example, the first set of outer casing 30 holes 90A, 90B, 90C, 90D, 90E could be used to enable 100% flow of the fluid, and the second set of outer casing 30 holes 90A, 90B, 90C, 90D, 90E could be used to enable 50% flow of the fluid. This could be implemented, for example, by including a flow restrictor in combination with the outlet connectors 93 for the second set of outer casing 30 holes 90A, 90B, 90C, 90D, 90E, or by other conventional means.

The use of an additional set of holes could also be useful where controlling outgoing fluid flow and return fluid flow simultaneously. In this example a first set of outer casing 30 holes 90A, 90B, 90C, 90D, 90E controls the outgoing fluid flow, and the second set of outer casing 30 holes 90A, 90B, 90C, 90D, 90E controls the return fluid flow.

Suitable materials for the various components of the valve arrangement described herein will be apparent to the skilled person, dependent on the use of the valve arrangement, and the fluid being controlled.

Various other modifications of the embodiments described above would also be apparent to a skilled person. As such, it is emphasised that the foregoing description is provided by way of example only, and is not intended to limit the scope of protection as defined with reference to the appended claims.

The invention is limited only by the appended claims. Variations, characteristics, advantages, implementations, constructions, arrangements, terminology, materials, dimensions, embodiments, illustrations, depictions, and examples composing the above description and accompanying drawings show some possible implementations of the invention without limiting the invention. It is not necessary that every implementation of the invention achieve or possess every advantage, purpose, or characteristic identified herein, and as such, one skilled in the art may effect various additions, changes, modifications, or omissions without departing from the scope or spirit of the invention or its legal equivalents.

All ranges are inclusive of the stated limits, the orders of magnitude thereof, and all values and ranges substantially therebetween unless otherwise defined.

Unless otherwise stated, every use of “and” forms an inclusive list comprising at least the conjoined elements, and every use of “or” forms an inclusive list comprising at least one element of conjoined elements. Unless otherwise stated, singular usage (e.g., ‘a’, ‘an’, or ‘the’) includes plurals of the same.

The order of recitations in a claim do not imply a temporal or ordered relationship unless unavoidable by the plain language of that claim. No claim may be interpreted to invoke 35 U.S.C. § 112(f) unless that claim recites “means for” or “step for.”

1. A valve arrangement comprising first and second valve components, the first valve component providing a plurality of discrete flow channels, each of the discrete flow channels having an inlet aperture and one or more outlet apertures, and the second valve component providing a port arrangement having an inlet port and at least two outlet ports,
the first and second valve components being movable relative to each other between a plurality of open flow positions,
wherein in each of the open flow positions the port arrangement is aligned with a different one of the discrete flow channels, such that the inlet port is brought into fluid connection with the inlet aperture of said flow channel, and at least one outlet port is brought into alignment with at least one outlet aperture of said flow channel.

2. The valve arrangement of claim 1, wherein the first valve component is an inner valve component and the second valve component is an outer valve component.

3. The valve arrangement of claim 1, wherein the second valve component partially or fully surrounds the first valve component.

4. The valve arrangement of claim 1, wherein the first valve component and the second valve component are arranged concentrically, and optionally wherein the second valve component is arranged concentrically about the first valve component.

5. (canceled)

6. The valve arrangement of claim 1, wherein the first valve component and the second valve component are arranged about a same central longitudinal axis.

7. The valve arrangement of claim 1, wherein the first and second valve components are rotatable relative to each other.

8. The valve arrangement of claim 1, wherein a relative movement of the first and second valve components is controlled by a positioning motor.

9. The valve arrangement of claim 8, wherein the positioning motor is a rotational motor.

10. The valve arrangement of claim 1, wherein the plurality of discrete flow channels is formed in an external wall of the first valve component, and optionally wherein the inlet apertures and the one or more outlet apertures of the discrete flow channels are formed in an exterior surface of the external wall of the first valve component.

11. (canceled)

12. The valve arrangement of claim 1, wherein the first valve component and/or the second valve component are cylindrically shaped.

13. The valve arrangement of claim 1, wherein the open flow positions and the discrete flow channels are spaced about a circumference of the first valve component, and optionally wherein the open flow positions and the discrete flow channels are equidistantly spaced about the circumference of the first valve component.

14. (canceled)

15. The valve arrangement of claim 1, wherein the discrete flow channels run parallel to a longitudinal axis of the first valve component and/or the second valve component.

16. The valve arrangement of claim 1, wherein the inlet port and at least two outlet ports are through-ports that extend through a wall of the second valve component.

17. The valve arrangement of claim 1, wherein at least one of the discrete flow channels comprises two or more outlet apertures.

18. The valve arrangement of claim 1, wherein the port arrangement has at least three outlet ports, wherein at least one of the discrete flow channels comprises three or more outlet apertures.

19. (canceled)

20. The valve arrangement of claim 1, wherein the first valve component further provides at least one discrete closed channel, the discrete closed channel comprising no outlet apertures, and optionally the first and second valve components being movable relative to each other to a closed position, wherein in the closed position the port arrangement is aligned with the discrete closed channel, such that none of the at least two outlet ports are aligned with an outlet aperture.

21. (canceled)

22. The valve arrangement of any preceding claim 1, wherein the port arrangement comprises an inlet connector arranged to fluidly connect the inlet port to an inlet flow in use, and at least two outlet connectors arranged to fluidly connect the at least two outlet ports to at least two separate outlets in use.

23. The valve arrangement of claim 22, wherein the at least two outlet connectors are adjustably movable relative to the second valve component to adjust a resistance to flow through the at least two outlet ports in use.

24. A system comprising two or more valve arrangements according to preceding claim 1.

25. The system of claim 24, wherein at least one of the one or more outlet ports of the second valve component of a first valve arrangement is fluidly connected to an inlet port of the second component of a second valve arrangement.
